(19) United States
(12) Patent Application Publication
(10) Pub. No.: US 2018/0186442 A1
(43) Pub. Date: Jul. 5, 2018

(54) SUPPORT STRUCTURE FOR ROTATING MACHINERY

(71) Applicant: DRESSER-RAND COMPANY, Olean, NY (US)

(72) Inventor: William C. Maier, Almond, NY (US)

(21) Appl. No.: 15/739,792

(22) PCT Filed: Jul. 6, 2016
(86) PCT No.: PCT/US2016/041075

§ 371 Date: Dec. 26, 2017

Related U.S. Application Data
(60) Provisional application No. 62/188,879, filed on Jul. 6, 2015.

(51) Int. Cl. B63H 21/30; F01D 25/28; F02C 7/20

(52) U.S. Cl. CPC B63H 21/305; F16M 5/00; F02C 7/20; F01D 25/28

(57) ABSTRACT

A support structure for rotating machinery is provided. The support structure may include a first main hollow support member and a second main hollow support member, each having a longitudinal axis and a square cross-section. The second main hollow support member may be coupled with the first main hollow support member such that the longitudinal axis of the second main hollow support member is substantially perpendicular to the longitudinal axis of the first main hollow support member. The support structure may also include a plurality of secondary support members, each coupled with the first main hollow support member, the second main hollow support member, or the first main hollow support member and the second main hollow support member, and configured to support the rotating machinery disposed on the support structure.

### BACKGROUND

Gas turbines are commonly used to drive generators for power generation or to drive process equipment such as turbo-compressors or pumps. In some applications, such as offshore applications, the gas turbine and driven component(s) may be mounted together on a support structure or frame, generally referred to as a baseplate, such that the gas turbine and driven component(s) may be mounted and dismounted as a unit at the site of use (e.g., an oil platform or a floating production, storage, and offloading (FPSO) unit).

In offshore applications, the support structure is generally mounted to a deck of a rig, platform, or vessel. The deck may experience torsional motion under the influence of wave action or other vibration and mechanical stresses, which may be transmitted to the support structure mounted thereto. In addition, torque may be generated between the gas turbine and driven component(s) during operation. The support structure may maintain the alignment of the respective shafts of the gas turbine and driven component(s) as various environmental and process loads are applied to the gas turbine and driven component(s).

In order to absorb the torque and other environmental and process loads applied to the gas turbine and driven component(s), the support structure is typically formed from round or I-beam support members. The corresponding shapes of such support members typically result in a support structure which is unduly heavy and prone to deformation under its own weight in transport sufficient to cause misalignment of the respective shafts of the gas turbine and driven component(s). Further, the corresponding shapes of such support members typically necessitate the use of complex interface shapes for either reinforcement or mating between the structural members.

What is needed, then, is a lighter weight support structure capable of improved resistance to environmental and process loads applied to the gas turbine and driven component(s) and further having support members coupled with one another via simple orthogonal interfaces.

### SUMMARY

Embodiments of the disclosure may provide a support structure for rotating machinery. The support structure may include a first main hollow support member having a longitudinal axis and a square cross-section, and a second main hollow support member having a longitudinal axis and a square cross-section. The second main hollow support member may be coupled with the first main hollow support member such that the longitudinal axis of the second main hollow support member is substantially perpendicular to the longitudinal axis of the first main hollow support member. The support structure may also include a plurality of secondary support members, each coupled with the first main hollow support member, the second main hollow support member, or the first main hollow support member and the second main hollow support member, and configured to support the rotating machinery disposed on the support structure.

Embodiments of the disclosure may further provide a base frame for a gas turbine and one or more driven components. The base frame may include a first main hollow support member having a longitudinal axis and a first mounting structure proximal an end portion thereof, the first main hollow support member further having a square cross-section. The base frame may also include a second main hollow support member having a longitudinal axis, a second mounting structure adjacent an end portion thereof, and a third mounting structure adjacent an opposing end portion thereof such that the first mounting structure, the second mounting structure, and the third mounting structure are arranged in an isosceles triangle configuration. The second main hollow support member may further have a square cross-section and may be coupled with the first main hollow support member such that the longitudinal axis of the second main hollow support member is substantially perpendicular to the longitudinal axis of the first main hollow support member. The base frame may further include a plurality of hollow secondary support members, each hollow secondary support member having a longitudinal axis and coupled with the first main hollow support member, the second main hollow support member, or the first main hollow support member and the second main hollow support member, such that the longitudinal axis of the hollow secondary support member is substantially perpendicular to the longitudinal axis of the first main hollow support member. Each hollow secondary support member may have a square cross-section and may be configured to support the gas turbine or the one or more driven components disposed on the base frame.

Embodiments of the disclosure may further provide a mounting system for a gas turbine and one or more driven components. The mounting system may include a base frame including a first main hollow support member having a square cross-section and a second main hollow support member having a square cross-section and coupled with the first main hollow support member such that the first main hollow support member and the second main hollow support member are arranged cruciformly. The base frame may also include a plurality of hollow secondary support members having a square cross-section. Each hollow secondary support member may be coupled with the first main hollow support member, the second main hollow support member, or the first main hollow support member and the second main hollow support member, and configured to support the gas turbine or the one or more driven components disposed on the base frame. The base frame may also include a plurality of mounting structures including a first mounting structure disposed on the first main hollow support member, a second mounting structure disposed adjacent an end portion of the second main hollow support member, and a third mounting structure disposed adjacent an opposing end portion of the second main hollow support member. The first mounting structure, the second mounting structure, and the third mounting structure may be arranged in an isosceles triangle configuration and configured to balance the weight of the gas turbine and the one or more driven components. The mounting structure may also include a plurality of damping mounts configured to mount the support structure to a substructure, where respective damping mounts of the plurality of damping mounts are coupled with the first mounting structure, the second mounting structure, and the third mounting structure.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a perspective view of a gas turbine operatively coupled to a plurality of driven components, where the gas turbine and the plurality of driven components are mounted to a support structure secured to a substructure, according to one or more embodiments.

FIG. 2A illustrates a top perspective view of the support structure shown in FIG. 1, according to one or more embodiments.

FIG. 2B illustrates a bottom perspective view of the support structure shown in FIG. 1, according to one or more embodiments.

FIG. 2C illustrates a side view of the support structure shown in FIG. 1, according to one or more embodiments.

FIG. 2D illustrates a front view of the support structure shown in FIG. 1, according to one or more embodiments.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

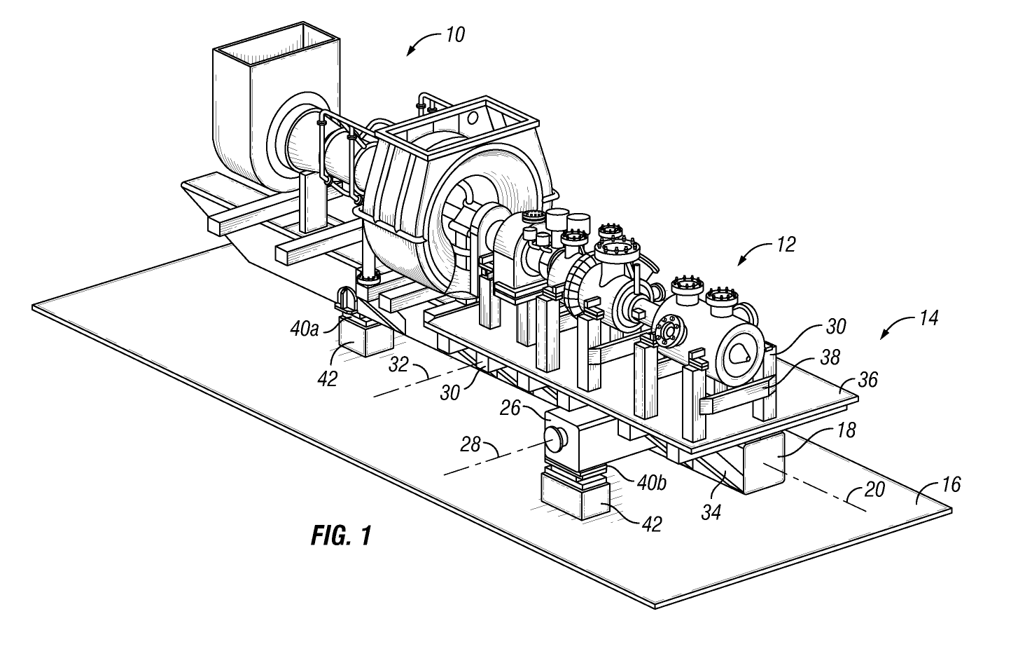

FIG. 1 illustrates rotating machinery in the form of a gas turbine 10 and driven components, generally indicated as 12 and including, for example, a generator and a compressor, operatively coupled with one another and disposed on a support structure 14. It should be appreciated that while the support structure 14 is particularly well-suited to a gas turbine, the present disclosure is not thereby limited. Other machines or engine types such as steam turbines or reciprocating engines might be substituted for the gas turbine 10 of FIG. 1 without departing from the scope of the present disclosure. Similarly, while the driven components 12 may include a generator and a compressor, a wide variety of other driven components such as a pump or gearbox may be included in or substituted for the driven components 12 without departing from the intended scope of the present disclosure.

The support structure 14, also referred to herein as a baseplate or base frame, is configured to provide a mounting interface for and to support the weight of the gas turbine 10 and the driven components 12 and to further couple the gas turbine 10 and the driven components 12 to a substructure 16, illustrated in FIG. 1 as a portion of a deck of an offshore facility. Illustrative examples of offshore facilities may include, but are not limited to, drilling rigs, drilling vessels, FPSO units, and production platforms. Although the substructure 16 in FIG. 1 is illustrative of an offshore facility, in one or more embodiments, the substructure 16 may be a component of an onshore facility, such as a refinery or liquefied natural gas (LNG) plant. It will be appreciated by skilled artisans that the support structure 14 may be utilized in a multitude of applications including, but not limited to, any application requiring machinery to be supported where a torque is or may be required to be absorbed.

The gas turbine 10 and/or the driven components 12, or parts thereof, may be housed in a light-weight sound absorbing housing. If the gas turbine 10 and the driven components 12 are to be mounted in an exposed location, the whole may be disposed in a housing (not shown) resistant to the winds and the weather. Such a housing may be mounted on and secured to the substructure 16 or to the support structure 14.

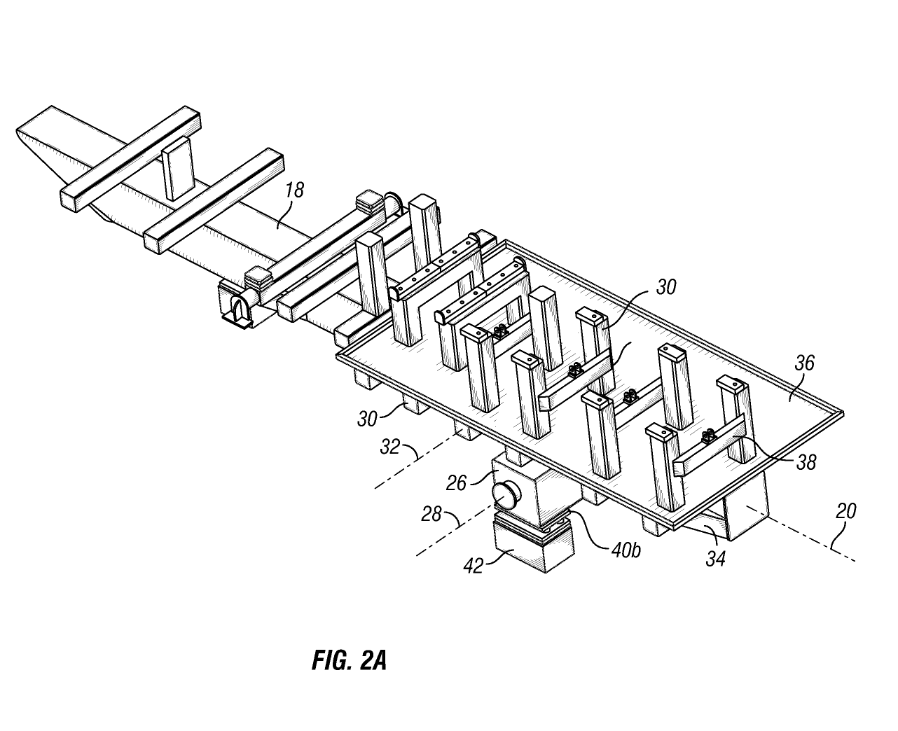

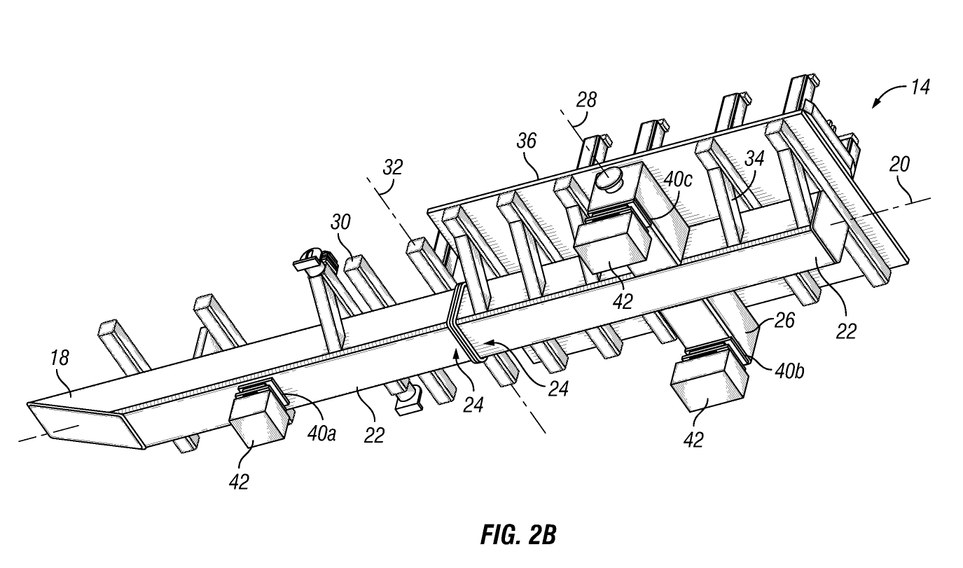

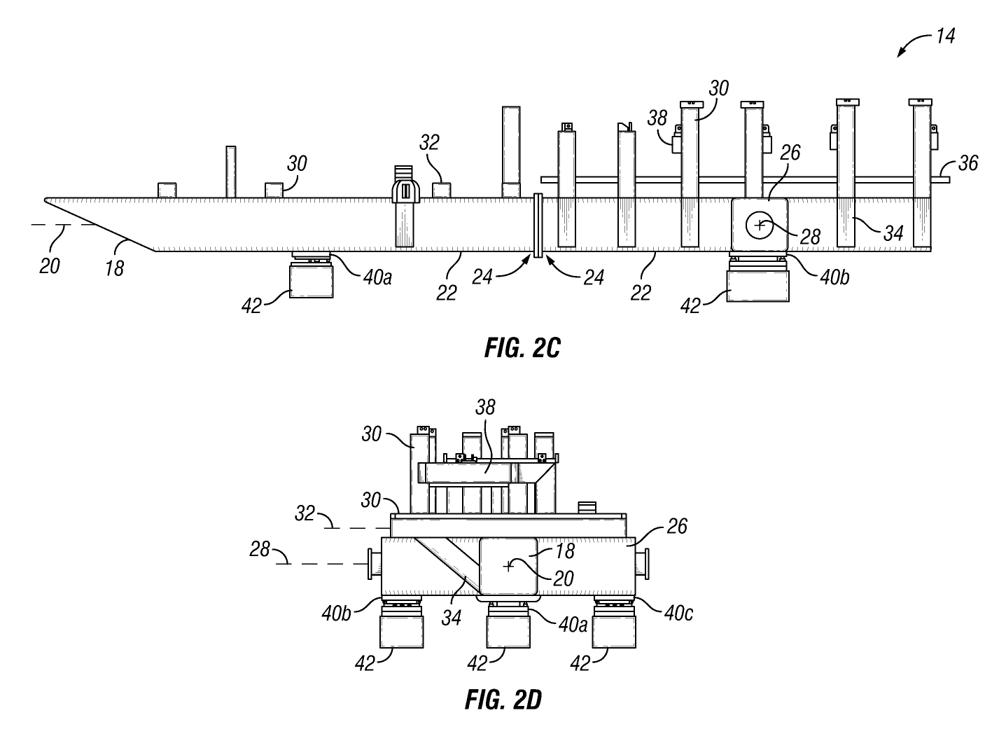

Referring now to FIGS. 2A-2D with continued reference to FIG. 1, the support structure 14 may include a first main support member 18 extending along the length of the support structure 14 and having a longitudinal axis 20. In an exemplary embodiment, the first main support member 18 may be hollow and constructed of steel and may further have a square cross-section along the length thereof. The use of a hollow, square-shaped cross-section for the first main support member 18 instead of the round cross-sections of the prior art results in simpler mounting interfaces, lower constructional height, and savings in weight. Further, the use of a hollow, square-shaped cross-section for the first main support member 18 instead of the I-beam cross-sections of the prior art results in increased torsional stiffness, which, at a minimum, reduces misalignment of the rotating shafts of the gas turbine 10 and driven components 12.

The first main support member 18 may be a single, unitary piece or component, or as illustrated most clearly in FIGS. 2B and 2C, the first main support member 18 may be formed from a plurality of first main support member segments 22. Each of the first main support member segments 22 may have at least one flanged end portion 24. As illustrated in FIGS. 2B and 2C, the first main support member 18 is formed from two first main support member segments 22 coupled with another via respective flanged end portions 24. The flanged end portions 24 of each first main support member segment 22 may define a plurality of apertures through which fastening members, e.g., bolts, may be inserted to couple the respective flanged end portions 24 of each first main support member segment 22 with one another to form the first main support member 18. The formation of the first main support member 18 from the plurality of first main support member segments 22 facilitates the parallel assembly and shipping of the gas turbine 10 and driven components 12 at separate locations, according to one or more embodiments.

The support structure 14 may also include a second main support member 26 extending laterally from the first main support member 18. The second main support member 26 may be integral or coupled, for example by welding, with the first main support member 18 and may have a longitudinal axis 28 oriented substantially perpendicular to, or about 90 degrees in relation to, the longitudinal axis 20 of the first main support member 18. As illustrated most clearly in FIG. 2B, the second main support member 26 and the first main support member 18 may be arranged cruciformly to distribute the load of the gas turbine 10 and driven components 12. In an exemplary embodiment, the second main support member 26 may be hollow and constructed of steel and may further have a square cross-section along the length thereof. As noted above, the use of a hollow, square-shaped cross-section over designs of the prior art reduces weight and constructional height, allows for simpler mounting interfaces, and increases torsional stiffness.

The support structure 14 may further include a plurality of secondary support members 30, where each secondary support members 30 may be coupled, for example by welding, with the first main hollow support member 18, the second main hollow support member 26, or the first main hollow support member 18 and the second main hollow support member 26 and configured to support the gas turbine 10 and driven components 12 disposed on the support structure 14. Each secondary support member 30 may have a longitudinal axis 32, and may be arranged such that the longitudinal axis 32 is substantially perpendicular to, or about 90 degrees in relation to, the longitudinal axis 20 of the first main hollow support member 18. Each secondary support member 30 may be hollow and constructed of steel and may further have a rectangular cross-section along the length thereof. In an exemplary embodiment, each secondary support member 30 may be hollow and constructed of steel and may further have a square cross-section along the length thereof. As noted above, the use of a hollow, square-shaped (or rectangular-shaped) cross-section over designs of the prior art reduces weight and constructional height, allows for simpler mounting interfaces, and increases torsional stiffness.

In an exemplary embodiment, the plurality of secondary support members 30 may be disposed on respective surfaces of the first main support member 18 and/or the second main support member 26 facing the gas turbine 10 and drive components 12 and further supported by respective bracing members 34 coupling one or more of the secondary support members 30 to the first main support member 18. The bracing members 34 may each be coupled, for example by welding, with the first main support member 18 and the respective secondary support member 30, such that each bracing member 34 may be configured as a diagonal brace to provide structural support for the respective secondary support members 30. Each bracing member 34 may be hollow and constructed of steel and may further have a rectangular cross-section. In an exemplary embodiment, each bracing member 34 may be hollow and constructed of steel and may further have a square cross-section. As noted above, the use of a hollow, square-shaped (or rectangular-shaped) cross-section over designs of the prior art reduces weight and constructional height, allows for simpler mounting interfaces, and increases torsional stiffness.

As illustrated in the Figures, one or more planar members 36 may be disposed on one or more of the plurality of secondary support members 30 and coupled therewith. In an exemplary embodiment, the planar members 36 may be steel plates forming a flooring to facilitate movement thereacross to allow an operator to access the gas turbine 10 and driven components 12; however, in other embodiments, the planar members 36 may be or include one or more drain pans configured to collect and provide drainage for a fluid discharged from the gas turbine 10 and/or the driven components 12. Accordingly, as illustrated, the planar members 36 may extend along the length of the gas turbine 10 and driven components 12. In one or more embodiments, end portions of the planar members 36 may be coupled with hollow structural members about the periphery of the planar members 36. The hollow structural members may provide additional structural support and/or form a channel or lip to retain or direct the fluid discharged from the gas turbine 10 and/or the driven components 12.

In an exemplary embodiment, one or more of the secondary support members 30 may extend vertically from another secondary support member 30 and the one or more planar members 36 and may be configured to couple with the gas turbine 10 or the driven components 12. The secondary support members 30 extending vertically may include respective mounting plates or pads configured to receive and mount thereupon the gas turbine 10 or the driven components 12. The secondary support members 30 may be coupled with adjacent secondary support members 30 via cross members 38 to provide structural rigidity.

The support structure 14 may be coupled with or mounted to the substructure 16 in the form of a three-point mounting system. The mounting system may include the support structure 14, where the support structure 14 includes a plurality of mounting points at which respective mounting structures 40a-c are located and configured to mount the support structure 14 to the substructure 16. In an exemplary embodiment, each of the mounting structures 40a-c includes one or more plates constructed of steel. The plurality of mounting structures may include a first mounting structure 40a disposed on the first main support member 18. In an exemplary embodiment, the first mounting structure 40a may be disposed at a location along the longitudinal axis 20 of the first main support member 18 determined to be suitable for balancing the load generated by at least the gas turbine 10. Thus, in one or more embodiments, the first mounting structure 40a may be disposed along the longitudinal axis 20 of the first main support member 18 at a location proximal the gas turbine 10. In an exemplary embodiment, the first mounting structure 40a is disposed at a location along the longitudinal axis 20 of the first main support member 18 adjacent an end portion of the first main support member 18. In another embodiment, the first mounting structure 40a is disposed at a location along the longitudinal axis 20 of the first main support member 18 underneath the center of gravity of the gas turbine 10.

The plurality of mounting structures 40a-c may also include a second mounting structure 40b and a third mounting structure 40c disposed on the second main support member 26. In an exemplary embodiment, the second mounting structure 40b and the third mounting structure 40c may be disposed at respective locations along the longitudinal axis 28 of the second main support member 26 determined to be suitable for balancing the load generated by at least the driven components 12. Thus, in one or more embodiments, the second and third mounting structures 40b, 40c may be disposed along the longitudinal axis 28 of the second main support member 26 at a location proximal the driven components 12. In an exemplary embodiment, the second mounting structure 40b may be disposed at a location along the longitudinal axis 28 of the second main support member 26 adjacent an end portion of the second main support member 26 and the third mounting structure 40c may be disposed at a location along the longitudinal axis 28 of the second main support member 26 adjacent an opposing end portion of the second main support member 26. As illustrated most clearly in FIG. 2B, as disposed on the support structure 14, the first mounting structure 40a, the second mounting structure 40b, and the third mounting structure 40c are arranged as corners of an isosceles triangle configuration and configured to balance the weight of the gas turbine 10 and driven components 12.

The mounting system may further include a plurality of damping mounts 42 configured to mount the support structure 14 to the substructure 16. In an exemplary embodiment, respective damping mounts 42 of the plurality of damping mounts 42 may be coupled with the first mounting structure 40a, the second mounting structure 40b, and the third mounting structure 40c. Each of the one or more plates of the first, second, and third mounting structures 40a-c may be configured to receive the respective damping mounts 42. In an exemplary embodiment, the damping mounts 42 may be compliant vibration damping mounts configured to support the load generated by the gas turbine 10 and driven components 12. As the damping mounts 42 may be likewise configured as corners of an isosceles triangle configuration and may be the sole means for supporting the support structure 14 on the substructure 16, such an arrangement greatly facilitates the installation of the support structure 14 on the substructure 16 and materially reduces the effect of any forces from the substructure 16 tending to distort the support structure 14 and produce misalignment of the shafts of the gas turbine 10 and driven components 12 mounted on and supported by the support structure 14.

As disclosed herein, the utilization of hollow, square-shaped cross-sectional support or structural members forming the support structure 14 allows for a lighter weight and more compact support structure 14 as opposed to circular tubing contemplated by the prior art. In addition, the torsional stiffness of the hollow, square-shaped cross-sectional support or structural members is superior to open-section, I-beam shapes contemplated by the prior art. Thus, alignment of rotating components, e.g., shafts, of the gas turbine 10 and driven components 12 may be maintained as various environmental and process loads are applied thereto. Preserving the alignment of the rotating components may, at a minimum, reduce wear of associated bearings and mounting components. Further, the utilization of I-beam or circular tube-shaped support members necessitates the use of complex interface shapes for either reinforcement or mating therebetween. In accordance with the embodiments disclosed herein, the utilization of hollow, square-shaped or rectangular cross-sectional support or structural members allows for minimal to no interface or adapter components due to the simple orthogonal interfaces provided by the square-shaped or rectangular cross-sectional support or structural members.

It should be appreciated that all numerical values and ranges disclosed herein are approximate valves and ranges, whether “about” is used in conjunction therewith. It should also be appreciated that the term “about,” as used herein, in conjunction with a numeral refers to a value that is +/−5% (inclusive) of that numeral, +/−10% (inclusive) of that numeral, or +/−15% (inclusive) of that numeral. It should further be appreciated that when a numerical range is disclosed herein, any numerical value falling within the range is also specifically disclosed.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

1. A support structure for rotating machinery, comprising:
a first main hollow support member having a longitudinal axis and a square cross-section, and comprising a plurality of first main hollow support member segments, each first main hollow support member segment having a flanged end portion, and each first main hollow support member segment coupled with another first main hollow support member segment via respective flanged end portions and fastening members;
a second main hollow support member having a longitudinal axis and a square cross-section, the second main hollow support member coupled with the first main hollow support member such that the longitudinal axis of the second main hollow support member is substantially perpendicular to the longitudinal axis of the first main hollow support member; and
a plurality of secondary support members, each coupled with the first main hollow support member, the second main hollow support member, or the first main hollow support member and the second main hollow support member, and configured to support the rotating machinery disposed on the support structure.

2. The support structure of claim 1, further comprising a plurality of mounting structures configured to mount the support structure to a substructure, the plurality of mounting structures comprising:
a first mounting structure disposed on the first main hollow support member;
a second mounting structure disposed adjacent an end portion of the second main hollow support member; and
a third mounting structure disposed adjacent an opposing end portion of the second main hollow support member,
wherein the first mounting structure, the second mounting structure, and the third mounting structure are arranged in an isosceles triangle configuration and configured to balance the weight of the rotating machinery.

3. The support structure of claim 2, wherein each mounting structure of the plurality of mounting structures comprises a mounting plate configured to couple with a compliant damping mount in contact with the substructure.

4. The support structure of claim 1, further comprising a plurality of bracing members, each bracing member coupling a respective secondary support member with the first main hollow support member.

5. The support structure of claim 4, wherein each bracing member of the plurality of bracing members is hollow and has a square cross-section.

6. The support structure of claim 1, wherein each secondary support member of the plurality of secondary support members has a longitudinal axis, wherein the longitudinal axis of each secondary support member is substantially perpendicular to the longitudinal axis of the first main hollow support member.

7. The support structure of claim 6, wherein each secondary support member is hollow and has a square cross-section.

8. The support structure of claim 7, wherein one or more secondary support members of the plurality of secondary support members extend vertically from another secondary support member, the one or more secondary support members configured to couple with the rotating machinery.

9. The support structure of claim 1, wherein the second main hollow support member is coupled with the first main hollow support member such that the first main hollow support member and the second main hollow support member are arranged cruciformly.

10. (canceled)

11. The support structure of claim 1, further comprising one or more planar members disposed on one or more of the plurality of secondary support members and coupled therewith, the one or more planar members configured to collect and provide drainage for a fluid discharged from the rotating machinery or configured to facilitate movement thereacross to access the rotating machinery by an operator.

12. A base frame for a gas turbine and one or more driven components, comprising:
a first main hollow support member having a longitudinal axis, a square cross-section, and a first mounting structure proximal an end portion thereof, and comprising a plurality of first main hollow support member segments, each first main hollow support member segment having a flanged end portion, and each first main hollow support member segment coupled with another first main hollow support member segment via respective flanged end portions and fastening members;
a second main hollow support member having a longitudinal axis, a second mounting structure adjacent an end portion thereof, and a third mounting structure adjacent an opposing end portion thereof such that the first mounting structure, the second mounting structure, and the third mounting structure are arranged in an isosceles triangle configuration, the second main hollow support member further having a square cross-section and being coupled with the first main hollow support member such that the longitudinal axis of the second main hollow support member is substantially perpendicular to the longitudinal axis of the first main hollow support member; and
a plurality of hollow secondary support members, each hollow secondary support member having a longitudinal axis and coupled with the first main hollow support member, the second main hollow support member, or the first main hollow support member and the second main hollow support member, such that the longitudinal axis of the hollow secondary support member is substantially perpendicular to the longitudinal axis of the first main hollow support member, and each hollow secondary support member having a square cross-section and being configured to support the gas turbine or the one or more driven components disposed on the base frame.

13. The base frame of claim 12, further comprising a plurality of bracing members, each bracing member coupling a respective secondary support member with the first main hollow support member, wherein each bracing member of the plurality of bracing members is hollow and has a square cross-section.

14. The base frame of claim 13, wherein;
the second main hollow support member is coupled with the first main hollow support member such that the first main hollow support member and the second main hollow support member are arranged cruciformly.

15. The base frame of claim 14, wherein one or more hollow secondary support members of the plurality of hollow secondary support members extend vertically from another hollow secondary support member, the one or more hollow secondary support members configured to couple with the gas turbine or the one or more driven components.

16. The base frame of claim 15, wherein each mounting structure of the plurality of mounting structures is configured to mount the base frame to a substructure and comprises a mounting plate configured to couple with a compliant damping mount in contact with the substructure.

17. The base frame of claim 16, further comprising one or more planar members disposed on one or more of the plurality of hollow secondary support members and coupled therewith, the one or more planar members configured to collect and provide drainage for a fluid discharged from the gas turbine or the one or more driven components or configured to facilitate movement thereacross to access the gas turbine or the one or more driven components by an operator.

18. A mounting system for a gas turbine and one or more driven components, comprising:
a base frame comprising:
a first main hollow support member having a square cross-section, and comprising a plurality of first main hollow support member segments, each first main hollow support member segment having a flanged end portion, and each first main hollow support member segment coupled with another first main hollow support member segment via respective flanged end portions and fastening members; and
a second main hollow support member having a square cross-section and coupled with the first main hollow support member such that the first main hollow support member and the second main hollow support member are arranged cruciformly;
a plurality of hollow secondary support members having a square cross-section, each hollow secondary support member coupled with the first main hollow support member, the second main hollow support member, or the first main hollow support member and the second main hollow support member, and configured to support the gas turbine or the one or more driven components disposed on the base frame;
a plurality of mounting structures, comprising:
a first mounting structure disposed on the first main hollow support member;
a second mounting structure disposed adjacent an end portion of the second main hollow support member; and
a third mounting structure disposed adjacent an opposing end portion of the second main hollow support member,
wherein the first mounting structure, the second mounting structure, and the third mounting structure are arranged in an isosceles triangle configuration and configured to balance the weight of the gas turbine and the one or more driven components; and
a plurality of damping mounts configured to mount the support structure to a substructure, wherein respective damping mounts of the plurality of damping mounts are coupled with the first mounting structure, the second mounting structure, and the third mounting structure.

19. The mounting system of claim 18, wherein the base frame further comprises:
a plurality of bracing members, each bracing member coupling a respective hollow secondary support member with the first main hollow support member, wherein each bracing member of the plurality of bracing members is hollow and has a square cross-section; and
one or more planar members disposed on one or more of the plurality of hollow secondary support members and coupled therewith, the one or more planar members configured to collect and provide drainage for a fluid discharged from gas turbine or the one or more driven components or configured to facilitate movement thereacross to access the gas turbine or the one or more driven components by an operator.

20. (canceled)
